(19) United States
(12) Patent Application Publication
(10) Pub. No.: US 2007/0011365 A1
(43) Pub. Date: Jan. 11, 2007

(54) Electric field device

(75) Inventors: Andreas Jurisch, Schwante (DE); Bert Winkler, Berlin (DE)

Correspondence Address: LERNER GREENBERG STEMER LLP, P O BOX 2480, HOLLYWOOD, FL, 33022-2480, US

(73) Assignee: Siemens AG, Munchen (DE)

(21) Appl. No.: 10/558,867

(22) PCT Filed: Mar. 18, 2005
(86) PCT No.: PCT/DE05/00519

§ 371 Date: Nov. 30, 2005

(30) Foreign Application Priority Data
Mar. 24, 2004 (DE) 10 2004 015 227.6

(51) Int. Cl. G06F 13/00; G06F 5/00; G06F 3/00; G05B 15/00

(52) U.S. Cl. 710/33; 710/52; 700/1; 710/8; 710/1

(57) ABSTRACT

The invention relates to an electric field device (1) comprising a computer-controlled least one input/output module (3a-3f) data inputs and/or data outputs. The central control module (2) and the at least one input/output module (3a-3f) are connected to one another via a data bus (4). In order to design a field device of this type as to enable a comparatively easy adaptation of the device software of the field device to its quantity schedule, the invention provides that the type and number of the module parameters of the at least one input/output module (3a-3f), which indicate data inputs and outputs, are provided by this at least one input/output module (3a-3f) in order to query the central control module (2). The invention also relates to a method for configuring the electric field device (1).

Automatically controlled processes, such as industrial manufacturing processes or distribution processes for water, gas or electrical power are generally controlled using so-called automated systems. These automated systems have so-called field devices arranged in the vicinity of the process which perform different tasks for process automation. Such field devices may thus be in the form of measuring devices, control devices, protective devices or devices for monitoring quality variables of the controlled process. The field devices are generally used to sense measurement data of the process to be controlled and to further-process this measurement data in accordance with the functions of the field device. The field devices are generally connected to one another and/or to central or local control centers for communication purposes in order to be able to exchange data.

The invention relates to an electric field device having a computer-controlled central control module and at least one input/output module having data inputs and/or outputs, the central control module and the at least one input/output module being connected to one another via a databus.

Such a field device has been disclosed, for example, in the Siemens device manual “SIPROTEC, Distanzschutz 7SA6, V4.3” [Distance protection], order number C53000-G1100-C156-3. The device manual describes, in particular in the chapter entitled “Montage und Inbetriebsetzung” [Fitting and initial use] (page 389 et seq.), an electric field device in the form of a protective device, in the case of which a processor module as a central control module and at least one input/output module are connected to one another via a flat ribbon cable as a databus.

The known field devices are generally delivered by the manufacturer in a quantity structure which is fixed by the customer as early as when the field device is ordered and can be identified using an order number, i.e., for example, the number of data inputs and outputs provided by the corresponding field device is fixed in accordance with this requirement. Internal device software (firmware), which is contained in the central control module, for the purpose of controlling the respective field device is matched to this quantity structure. This matching is either fixedly predetermined by the manufacturer or, in certain sectors, can be set by means of generally manual configuration of the device software. On initial use and in the event of possible changes (for example extending a field device by further data inputs and outputs), complex reconfiguration of the field device often needs to be carried out. For this purpose, either a newly matched firmware needs to be run or, if possible, the configuration of the device software needs to be matched manually to the new quantity structure.

The invention is based on the object of designing an electric field device of the abovementioned type such that the device software can be matched to its quantity structure in a comparatively simple manner.

This object is achieved according to the invention by an electric field device of the specified type, in which the at least one input/output module makes available module parameters, which specify the type and number of its data inputs and/or outputs,

for them to be called up by the central control module. The essential advantage of the field device according to the invention consists in the fact that the at least one input/output module now makes available the information on the type and number of its data inputs and/or outputs itself. The type of data inputs and/or outputs is in this case understood to mean whether it is a data input or a data output. In this manner, it is largely unnecessary for manual adjustments to be made to match the field device, and configuration can take place automatically.

One advantageous embodiment of the field device according to the invention provides for the at least one input/output module to have an interface for connection to the databus and for the module parameters to be made available by means of the interface. The module parameters can thus be made available by the interface alone without additional components being required.

For this purpose, the interface may have a memory chip, in which the module parameters are stored. However, it is also possible for the memory chip to be arranged on the input/output module such that it is detached from the interface. The module parameters can be read from the memory chip and transmitted to the central control module where they are used for automatic configuration of the quantity structure of the field device.

As an alternative to a memory chip, in which the module parameters are stored, in accordance with one development of the field device according to the invention provision may also be made for the interface to have connections for connecting them electrically to the databus, the module parameters being made available by the connections being occupied in a prescribed manner on the side of the input/output module. As a result, it is possible in a simple manner for a type of mechanical encoding to be provided, by means of which the module parameters are specified. For example, the number of specific occupied connections, i.e., for example, connections with a voltage applied to them, can specify the number of available data inputs and outputs. By means of further reserved connections being occupied, it is then possible for a statement to be made as to whether it is a data input or a data output, in each case.

The databus may have any desired design, for example it may be in the form of a parallel databus. In accordance with a further embodiment of the field device according to the invention, however, it is considered to be particularly advantageous if the databus is a serial data link having a transmission rate of at least 100 Mbit/s. With such a serial data link, data can be transmitted between the individual input/output modules and the control module at the required speed. Examples of appropriately fast serial data links are the so-called firewire interface or USB 2.0, which are standardized in accordance with IEEE 1394.

In accordance with a further advantageous embodiment of the field device according to the invention, provision is made for the databus to be designed for electrically isolated, differential data transmission. Such a design of the databus makes it possible to largely rule out any interference between individual transmission channels of the databus. Electrically isolated in this case means that there are no electrical connections from ground or a voltage supply between individual transmission channels; differential data transmission methods are in this case understood to mean data transmission such that a useful signal is transmitted by means of two conductors of a transmission channel, and the receiver reconstructs the useful signal from the difference in the two signal levels. Forming the difference results in interference and effects which act equally on both conductors of the transmission channel.

The databus is also advantageously realized by an optical waveguide data link. The use of optical waveguides may ensure a high transmission rate with largely fault-free operation.

One further advantageous embodiment of the field device according to the invention also provides for the databus to be extended beyond the electric field device and, in addition to the at least one input/output module, for at least one further input/output module to be connected to the central control module via the extended databus. In this manner, the quantity structure, which can be realized in an existing field device, is no longer tied to the dimensions of the housing of the field device. If the space in the field device housing is no longer sufficient, it is possible in a simple manner for one or more further input/output modules to be arranged outside the actual field device and for them to be connected to the field device via the databus.

In order to protect such external input/output groups against external interference, provision may advantageously be made for the at least one further input/output module to be arranged in a separate housing.

In order to minimize electrical interference between the individual input/output modules further still, provision is made for each input/output module to have a dedicated voltage supply.

In addition, the electric field device may have an indicator apparatus for the purpose of representing the module parameters.

The abovementioned object is also achieved by a method for configuring an electric field device, the field device comprising a computer-controlled central control module and at least one input/output module, which is connected to the control module and has data inputs and/or outputs, and the method having the following steps:

the respective input/output module makes available module parameters, which specify the type and number of the respective data inputs and/or outputs, and these module parameters are transmitted to the central control module, and the module parameters are incorporated in a hardware drive, which drives the at least one input/output module, of the central control module whilst completing the configuration of the field device. In this manner, by means of transmitting information, which is already available on each input/output module, on the type and number of the respectively available data inputs and outputs to the central control module and incorporating this information in a hardware drive which controls the respective input/output module, it is possible for automatic configuration to be carried out in a comparatively simple manner.

In the case of the method according to the invention, provision may advantageously be made for the module parameters to be represented on an indicator device. In this manner, the current quantity structure of the field device can be represented on the field device by means of an indicator device, for example a display, with the result that the operator of the field device can see the respective current quantity structure.

In accordance with a further advantageous embodiment of the method according to the invention, provision is also made for the module parameters to be transmitted via a databus using encoding with no DC level. Owing to the encoding with no DC level, interference and faults between the individual input and output modules and the central computer module can be minimized.

In accordance with a further advantageous embodiment of the method according to the invention, provision is finally made for the module parameters to be transmitted via a data link at a transmission rate of at least 100 Mbit/s. In this manner, data can be transmitted between the input/output modules and the computer module at the required speed.

In order to explain the invention in more detail, in the drawings:

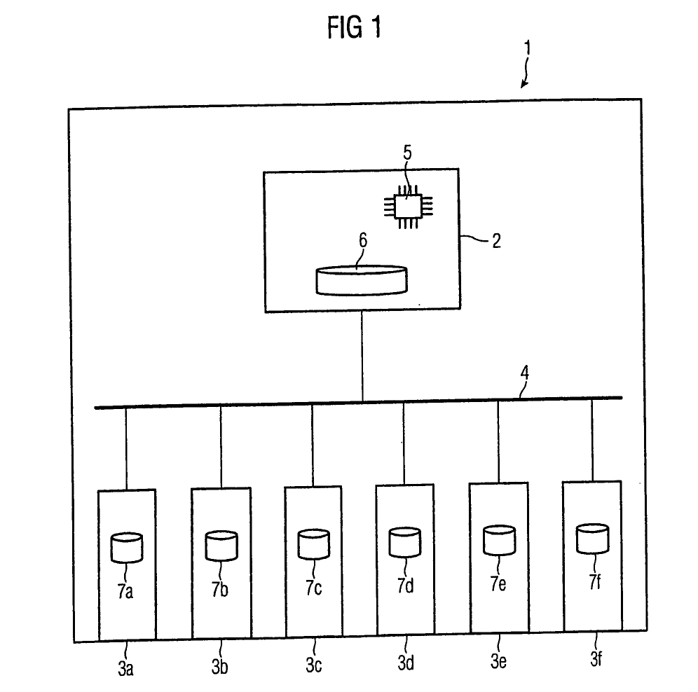

FIG. 1 shows a schematic illustration of an exemplary embodiment of an electric field device, and

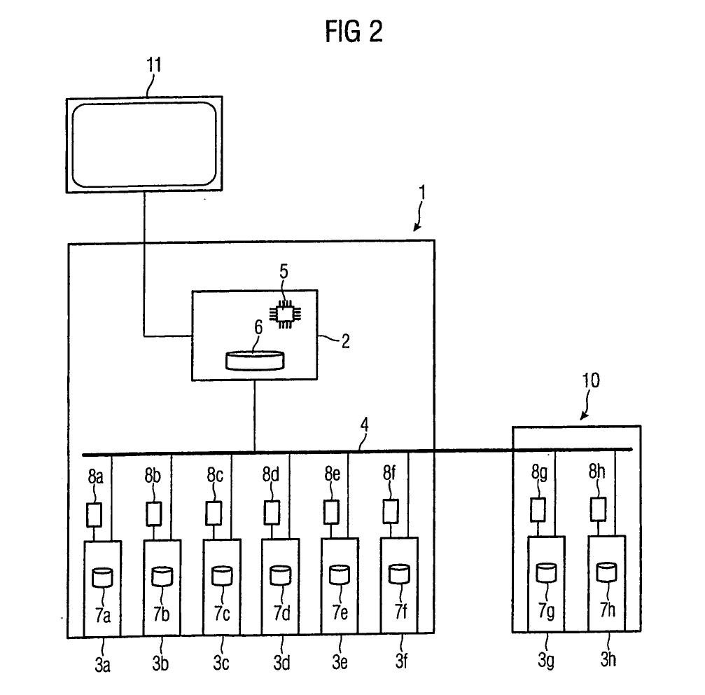

FIG. 2 shows a schematic illustration of a further exemplary embodiment of an electric field device.

FIG. 1 shows an electric field device 1, which has a computer-controlled central control module 2 and two or more input/output modules 3a to 3f. The field device 1 is connected to a process to be controlled (not shown in the figure), for example an electrical power supply line, via the input/output modules 3a to 3f. For this purpose, converter devices are provided in the process, by means of which converter devices process values are converted into measured values, which can be processed for the field device 1 and are fed to the input/output modules 3a to 3f of the field device 1.

The measured values received by the input/output modules 3a to 3f are transmitted to the central control module 2 and are processed there by means of a computer device 5. For this purpose, the input/output modules 3a to 3f and the central control module 2 are connected via a databus 4 in the form of a serial data link having a transmission rate of at least 100 Mbit/s. Such a serial data link may be designed in accordance with the standard for serial high-speed data links, which is generally known as “firewire”, for example. As a result, fast data transmission is ensured between the input/output modules 3a to 3f and the central control module 2. In order to avoid faults in the data transmission, the serial databus 4 is either configured using optical waveguides or a differential, electrically isolated electrical data link.

The measured values received by the input/output modules 3a to 3f are transmitted to the central control module 2 via the databus 4 and are processed there by means of the computer device 5, which may be, for example, a microprocessor. For this purpose, the computer device 5 executes a device software prescribed in the central control module 2.

When the field device 1 is initially used or in the event of changes, for example extensions to the field device by a further input/output module, this device software needs to be matched to the respective new quantity structure of the field device 1. For this purpose, the device software has a hardware drive 6, which carries out maintenance of the input/output modules 3a to 3f and controls the communication between the input/output modules 3a to 3f and the central control module 2.

In order to adjust the hardware drive 6 in an efficient manner—and thus also the device software of the central control module 2—the input/output modules 3a to 3f each have a memory chip 7a to 7f, in which module parameters are stored which specify the type and number of data inputs or outputs made available by the respective input/output module. For example, let us assume that the input/output module 3a has five data inputs and eight data outputs. In an analogous manner, the remaining input/output modules 3b to 3f each have dedicated combinations of data inputs or outputs. In the first data link between the respective input/output modules and the central control module 2, the respective module parameters are transmitted from the corresponding input/output module 3a to 3f to the central control module 2. There, the module parameters are incorporated in the hardware drive 6, which subsequently makes it possible for the central control module 2 to manage the individual data inputs or outputs of the respective input/output modules 3a to 3f.

The memory chips 7a to 7f may be in the form of separate chips, as shown in FIG. 1. However, it is also possible for a respective memory chip to be integrated into an interface of the input/output module for connecting them electrically to the databus.

In addition, a purely mechanical encoding of the module parameters in the form of a corresponding design for connections of the interface being occupied may also be provided instead of a memory chip.

In order that there is no interference between the individual input/output modules 3a to 3f and the central control module 2, the data transmission is carried out using a transmission code with no DC level. Direct currents in the form of constant high or low states are thus not produced by the individual input/output modules 3a to 3f on the lines of the databus 4 which, owing to their DC effect, may lead to interference between the individual input/output modules 3a to 3f or the central computer module 2 and to falsification of transmitted data. One example of a transmission code with no DC level is the Manchester code used, for example, in network technology.

FIG. 2 shows a further exemplary embodiment of an electric field device 1, components analogous to those in FIG. 1 being identified by the same references for reasons of clarity. In FIG. 2, an external housing 10 having further input/output modules 3g and 3h, which would no longer find any space in the original housing of the field device 1, are connected to the electric field device 1 as an extension of the existing electric field device 1. For this purpose, the serial databus 4 is extended
beyond the housing of the electric field device 1 and is drawn into the separate housing 10. With this extension of the serial databus 4, the further input/output modules 3g and 3h are now connected. These further input/output modules 3g and 3h, in analogy to the other input/output modules 3a to 3f, have memory chips 7g and 7h, in which module parameters are stored which specify the type and number of the data inputs or outputs available on each input/output module. Matching of the hardware drive 6 of the central control module 2 of the electric field device 1 to the newly added input/output modules 3g and 3h takes place in a similar manner to that described in relation to FIG. 1 by transmission and incorporation of the module parameters of the newly added input/output modules 3g and 3h. Since the serial databus 4 makes available a high data transmission speed of at least 100 Mbit/s, an extension of the databus 4 beyond the original housing of the field device 1 can be carried out without any disadvantages as regards transmission speed.

In order to avoid interference between the individual input/output modules 3a to 3h, which interference may stem from a common voltage supply, each individual input/output module is equipped with a dedicated voltage supply 8a to 8h. In this manner, interference which occurs with respect to an input/output module owing to their voltage supplies is restricted to this one input/output module and does not transfer to all of the input/output modules.

The field device 1 also has an indicator apparatus 11, as is illustrated highly schematically in FIG. 2, which may either be a direct component of the field device 1 or represents a separate indicator apparatus. The quantity structure of the field device 1 which is configured automatically by the field device 1, i.e. all of the input/output modules 3a to 3h with their associated data inputs and outputs, can be indicated by means of this indicator apparatus 11. As a result, an operator of the electric field device 1 can see and check the quantity structure.

1-15. (canceled)

16. An electric field device, comprising:
a computer-controlled central control module;
at least one input/output module having data inputs and/or data outputs;
a databus connecting said central control module and said at least one input/output module to one another; and
said at least one input/output module rendering available, for call-up by said central control module, module parameters specifying a type and a number of said data inputs and/or said outputs.

17. The electric field device according to claim 16, wherein:
said at least one input/output module includes an interface for connection to said databus; and
said interface is configured to render available the module parameters.

18. The electric field device according to claim 16, wherein said at least one input/output module includes a memory chip storing the module parameters.

19. The electric field device according to claim 17, wherein:
said interface has connectors for electrical connection to said databus, and the module parameters are made available at said connectors in accordance with an occupation of said connectors prescribed by said input/output module.

20. The electric field device according to claim 16, wherein said databus is a serial data link having a transmission rate of at least 100 Mbit/s.

21. The electric field device according to claim 16, wherein said databus is configured for electrically isolated, differential data transmission.

22. The electric field device according to claim 16, wherein said databus is an optical waveguide data link.

23. The electric field device according to claim 16, wherein:
said databus is extended beyond the electric field device; and
said at least one input/output module includes a further input/output module connected to said central control module via said extended databus.

24. The electric field device according to claim 23, wherein said at least one further input/output module is disposed in a separate housing.

25. The electric field device according to claim 23, wherein each of said input/output modules includes a dedicated voltage supply.

26. The electric field device according to claim 16, which further comprises a display for indicating the module parameters.

27. A method for configuring an electric field device having a central computer-controlled control module and at least one input/output module, connected to the control module and having data inputs and/or outputs, the method which comprises the following steps:
the respective input/output module making available module parameters, the module parameters specifying a type and a number of respective data inputs and outputs;
transmitting the module parameters to the central control module; and
incorporating the module parameters in a hardware drive, for driving the at least one input/output module, of the central control module while completing a configuration of the electric field device.

28. The method according to claim 27, which further comprises displaying the module parameters on an indicator device.

29. The method according to claim 27, which comprises transmitting the module parameters via a data link using encoding with no DC level.

30. The method according to claim 27, which comprises transmitting the module parameters via a data link at a transmission rate of at least 100 Mbit/s.
